(19) United States
(12) Patent Application Publication
(10) Pub. No.: US 2026/0019538 A1
(43) Pub. Date: Jan. 15, 2026

(54) MONITOR WITH INTEGRATED DUAL 5G

(71) Applicant: Mountain N Meadow Holdings, Inc., Ft. Lauderdale, FL (US)

(72) Inventor: James Devericks, Ft. Lauderdale, FL (US)

(21) Appl. No.: 19/268,876

(22) Filed: Jul. 14, 2025

Related U.S. Application Data
(60) Provisional application No. 63/671,355, filed on Jul. 15, 2024.

(51) Int. Cl. H04N 7/20

(52) U.S. Cl. CPC H04N 7/20

(57) ABSTRACT

The present disclosure relates generally to the methods of receiving streaming media on a monitor through one or more RF transceivers that are integrated directly into the monitor. While most modern monitors have built-in Wi-Fi radio transceivers, there are better options available with the onset of 5G cellular and 5G satellite technologies, referred to as Dual 5G, that provide better flexibility and connectivity in the environments where these monitors are used. Interconnectivity between multiple monitors can provide for an optimized mesh network or hybrid mesh network within one or more environments. These technologies can often be upgraded to improve performance with software upgrades throughout the life cycle of the product.

### PRIORITY CLAIM

In accordance with 37 C.F.R. 1.76, a claim of priority is included in an Application Data Sheet filed concurrently herewith. Accordingly, the present invention claims priority to Patent Application No. 63/671,355, entitled U.S. Provisional “MONITOR WITH INTEGRATED DUAL 5G”, filed Jul. 15, 2024. The contents of the above referenced application are incorporated herein by reference in their entirety.

### FIELD AND BACKGROUND OF THE INVENTION

The present device and system relates to computer monitors and, more specifically, to computer monitors that are capable of providing access to internet to those in the immediate area of the computer monitor.

Unless otherwise specified, all references to monitors in this description include television (TV) monitors, computer monitors, and other fixed and/or mobile displays found in homes, offices, medical facilities, ports (airports, sea ports, etc.), industrial facilities, restaurants and bars, retail stores, automobiles, trucks, recreational vehicles, and anywhere else a media content might be played, received, and/or streamed for still images, moving images and videos, text, and/or other visual material. The media displayed on these monitors is used for a wide range of purposes including entertainment, advertising, consumer electronics, personal computers, transportation, industrial equipment, medical imaging, and more.

The location of a monitor inside of a building structure, vehicle, or wherever else it might be placed will be referred to as the “environment” throughout this document. The environment may be fixed or mobile, single story or multi-level, and may be constructed from wood, concrete, steel, plastic, carbon fiber, or a combination of these and/or many other materials.

All references to monitors with one or more integrated radio frequency (RF) transceivers throughout this document are general statements and are exemplary or illustrative of typical use for the purpose of explaining this design. Every effort will be made to be clear and concise throughout the specification for this patent application. Furthermore, the Monitor with Dual 5G will be interchangeably referred to as “device” or “module” or “apparatus” throughout this document. It IS the intent of this application to focus on monitors with one or more integrated 5G RF technologies and or 6G or next generation of technologies going forward and backward compatible to 4G, 4G LTE, etc.

Current monitor technology physically comes in the form of a flat screen monitor (sometimes curved) with several display technologies available, including LCD, LED, PDP, OLED, or EL technology. The technologies are always improving with new forms of illumination, improved resolution, thinner and lighter enclosures, and reduced power consumption. These monitors have user controls to adjust the brightness, sharpness, aspect ratio, Wi-Fi connectivity, and more. They also have multiple inputs for audio, video, USB, HDMI, and more. Monitors can be mounted to walls using movable arms or fixed brackets, or they can be set on stands and placed onto tables or other horizontal surfaces. They come in many different sizes and in many different aspect ratios as well.

### SUMMARY OF THE INVENTION

While there are countless monitors around us wherever we may be, the media that we see is ported to those monitors by means of hardwired cables or over Wi-Fi. Almost all new monitors commercially available off-the-shelf today have integrated Wi-Fi radio transceivers based upon the IEEE 802.11 family of standards which are commonly used for local area networking of devices, Internet access, and allowing nearby digital devices to exchange data by means of radio waves.

Wi-Fi eliminates the need for hardwired cables. In cases where one might want to upgrade an older monitor that does not have integrated Wi-Fi, there are many aftermarket modules that are commercially available off-the-shelf, such as an Amazon Fire TV Stick™ and Roku™ that allow a user to add Wi-Fi technology to an older monitor.

These existing technologies communicate with an access point in the environment, commonly referred to as a gateway, router, and/or modem. This “master” gateway is often hardwired into the environment and then broadcasts a Wi-Fi signal throughout the environment to all of the communicating wireless digital “slave” devices and wireless devices requiring Internet access within the environment (IoT devices). The quality of signal reception from this single gateway, Received Signal Strength Indicator (RSSI), is limited by the location of the gateway within the physical building structure, the building materials used to construct the structure, and the hardware, software, and power limitations of the Wi-Fi technology.

Most homes and/or businesses, the environment, have a single access point from which Wi-Fi is ported into the environment and then broadcast. The Wi-Fi signal is often weakened by distance between devices, absorption and reflection of RF into various building materials, and even blocking electromagnetic fields from entering a steel reinforced structure due to phenomena like the Faraday cage.

Hardwiring is often unreliable due to excessive cable lengths, improperly crimped wires, and/or oxidized electrical contacts. By eliminating the hardwired access point and replacing wireless Internet gateway, the Wi-Fi communication speeds and RSSI within that environment are most often better than their wired counterparts.

The 5G signal can be transmitted from a 5G cellular tower or 5G satellite and received by the 5G fixed wireless gateway within the environment. The 5G fixed wireless gateway will then communicate with all of the Wi-Fi devices within that environment. This is commonly referred to as 5G Internet.

Thus, it is an objective of the present invention to provide a computer monitor that is constructed to function as an internet gateway.

It is also an objective of the present invention to provide a computer monitor that is constructed to provide at least a 5G internet gateway.

It is another objective of the present invention to provide a computer monitor that includes an RF transceiver to allow those in radio wave range to receive bi-directional internet communication through the computer monitor.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a front perspective view of a monitor;

FIG. 2 is a rear perspective view of the monitor illustrated in FIG. 1;

FIG. 3 is a top orthographic view;

FIG. 4 is a front orthographic view with local cross-section;

FIG. 5 is a building structure with a 5G cellular tower showing mesh network;

FIG. 6 is a building structure with 5G satellite showing mesh network;

FIG. 7 is a building structure with 5G cellular tower and satellite showing mesh network;

FIG. 8 is a building structure with “telephone” pole showing single access point;

FIG. 9 is a building structure with 5G cellular tower showing single access point; and

FIG. 10 is a building structure with 5G satellite showing single access point.

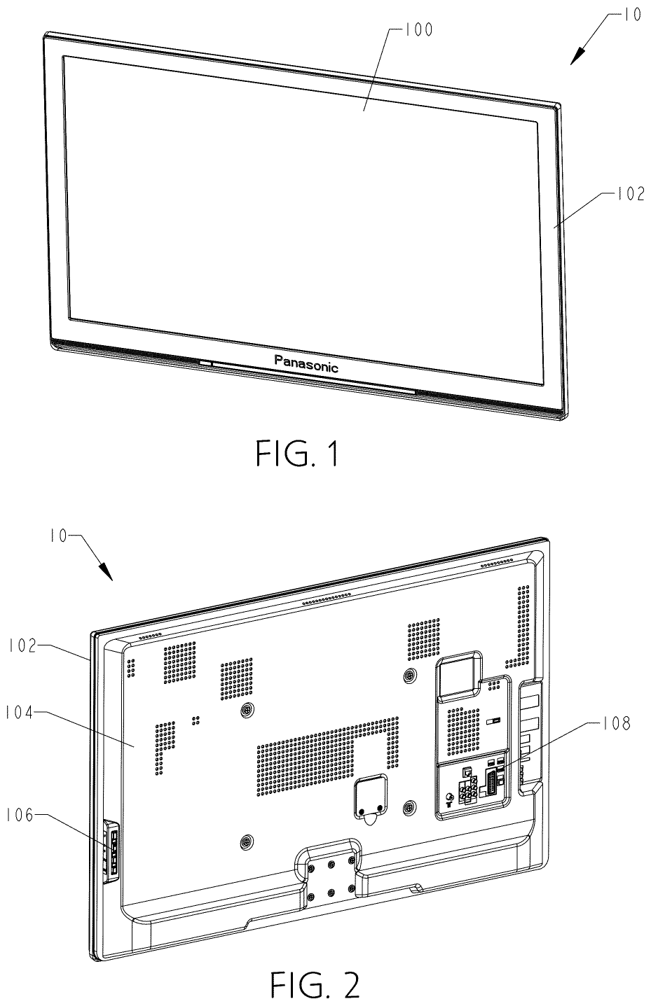

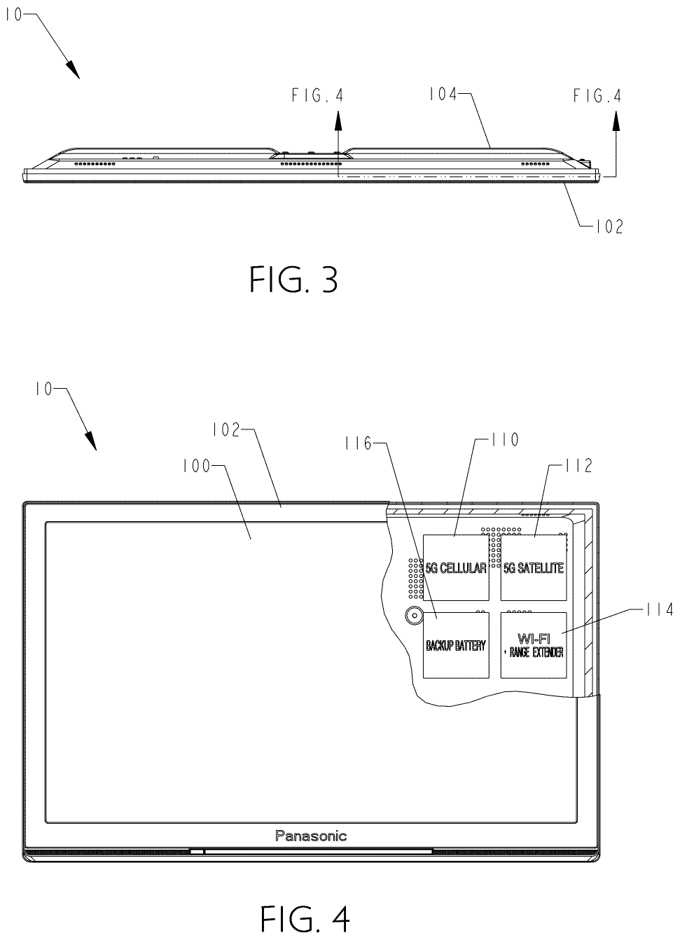

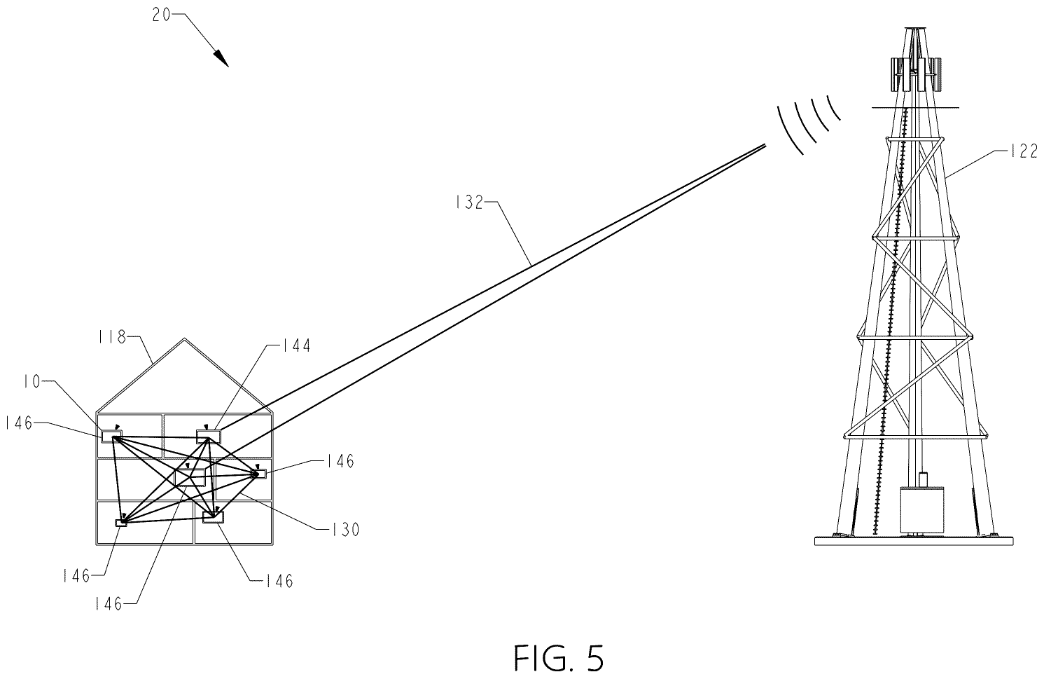

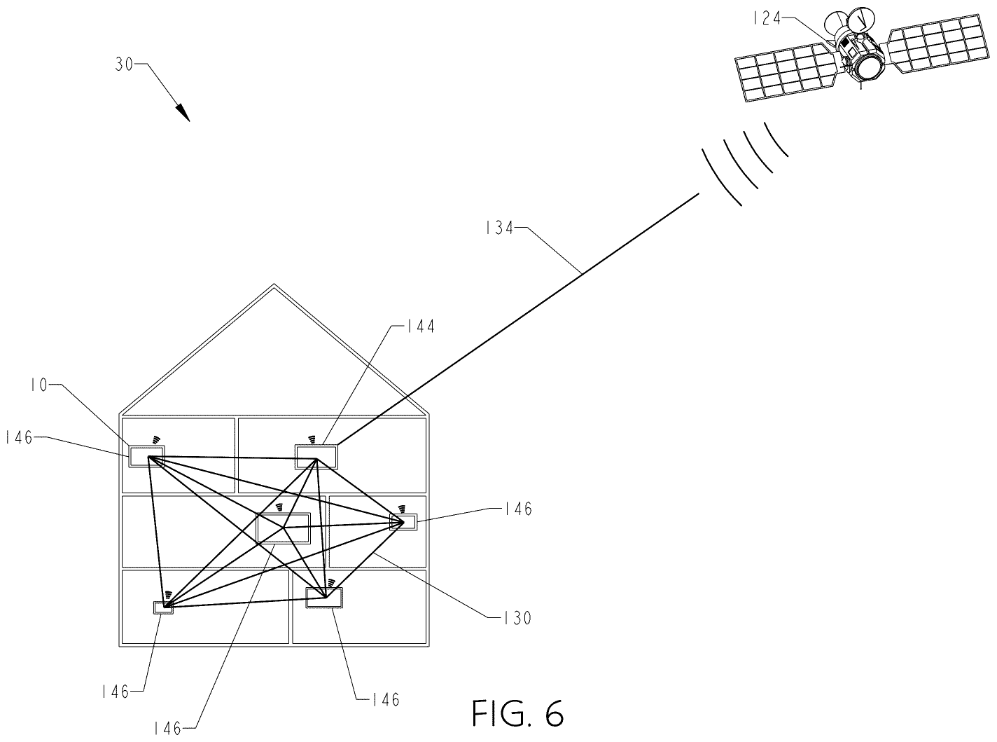

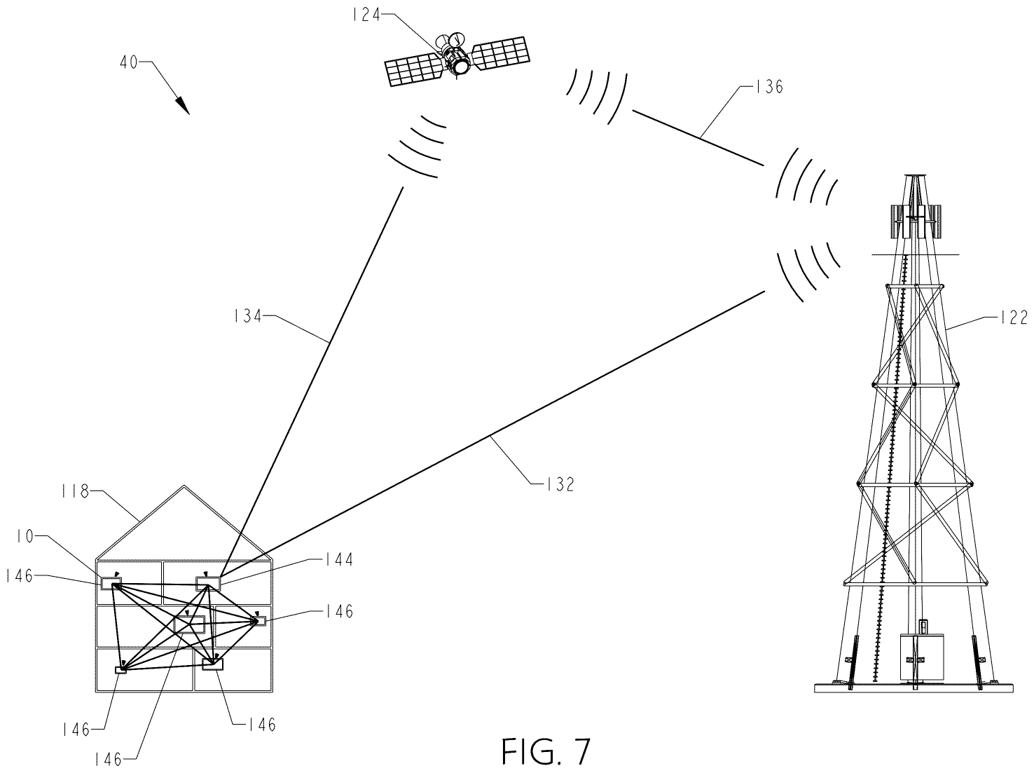

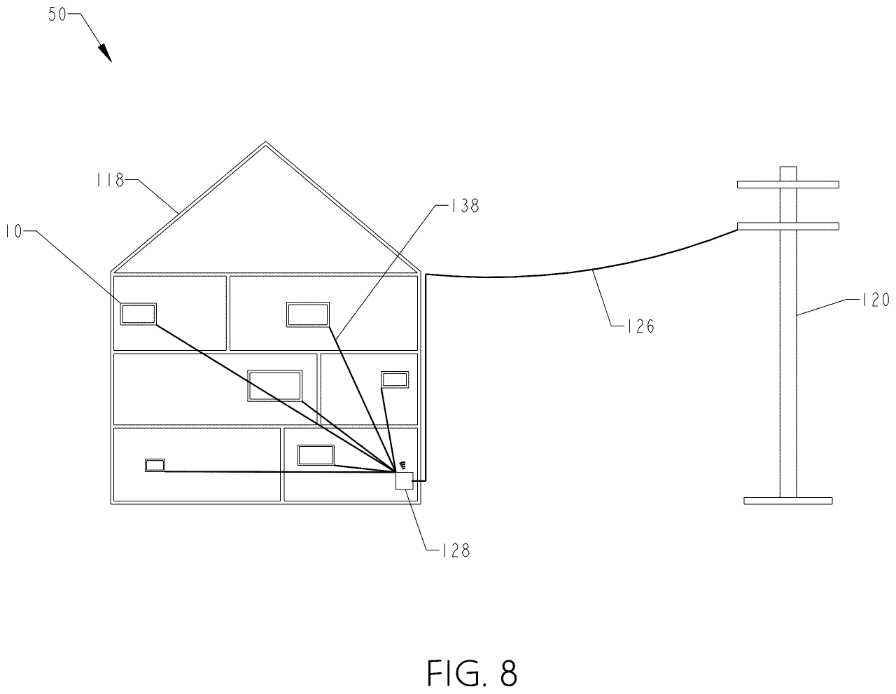

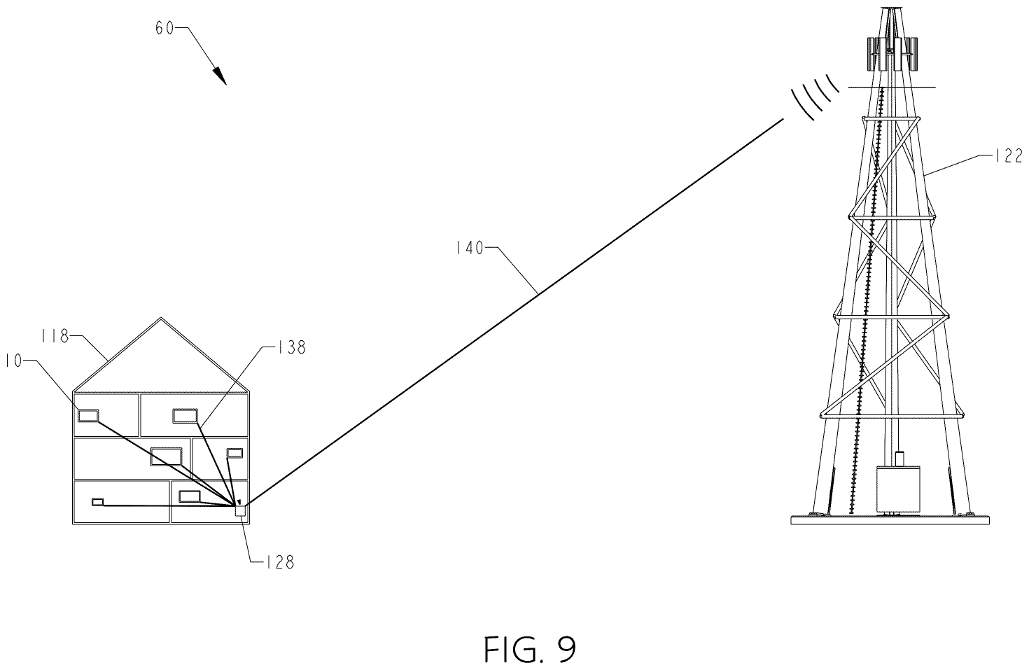

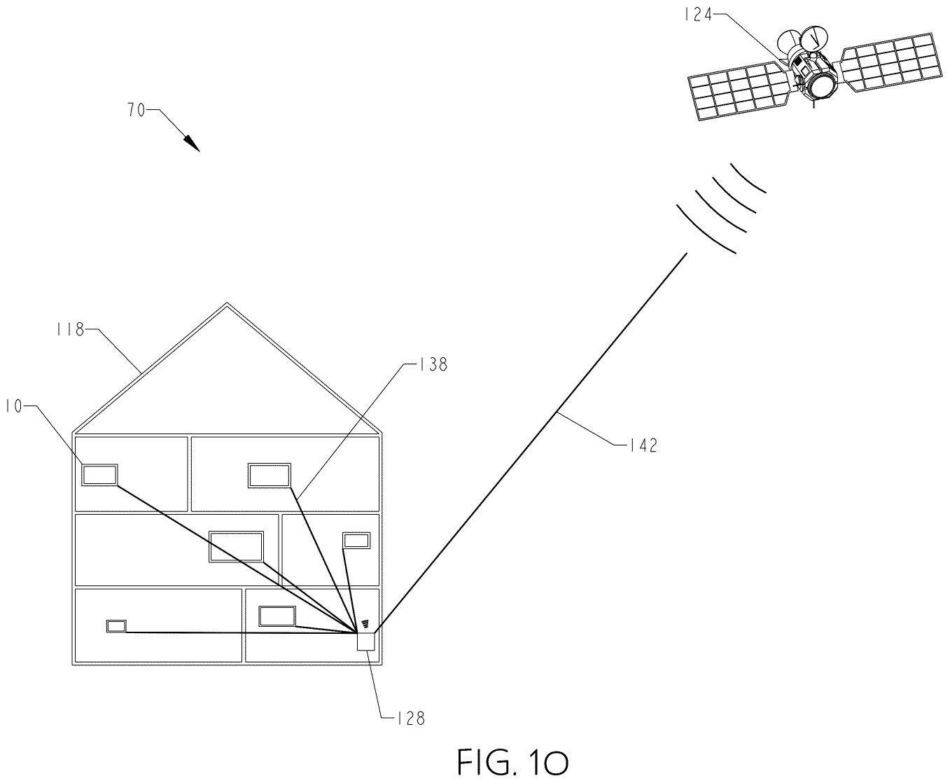

### DETAILED DESCRIPTION OF THE INVENTION

While the present invention is susceptible of embodiment in various forms, there is shown in the drawings and will hereinafter be described presently preferred, albeit not limiting, embodiments with the understanding that the present disclosure is to be considered exemplifications of the present invention and not intended to limit the invention to the specific embodiments illustrated.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” “perspective” and derivatives thereof, shall relate to the invention as oriented in the Figures. Furthermore, there is no intention to be bound by any expressed or implied theory presented in the preceding technical field, background, abstract, or the following detailed description.

It is also to be understood that the specific devices and processes illustrated in the attached drawings, and described in the following specification, are simply exemplary embodiments of the inventive concepts defined in the appended claims. Hence, specific dimensions, size and proportion, and other physical characteristics relating to the embodiments disclosed herein are not to be considered as limiting, unless the claims expressly state otherwise.

Monitors 10 come in many shapes and sizes. They typically have a flat or curved screen 100, a front housing 102, a rear housing 104, several user controls 106, a variety of input/output (I/O) ports 108, and countless circuit boards, electronic components, connectors, shielding, and power supplies internal to the housings that make up the overall end product. All of these items are fastened together with screws, snaps features, crimps, adhesives, and a variety of other mechanical hardware and processes.

Rather than integrating only Wi-Fi radios 114 into monitors 10, the present device replaces these Wi-Fi radios with 5G radios 110, 112 that can receive both 5G cellular 132 and 5G satellite 134 signals. Then one entire layer of communication can be eliminated as the signal will no longer have to be received by a single access point 128 and then repeated over Wi-Fi within the environment. Every monitor in the environment will be capable of directly receiving a 5G signal in order to stream media and data, thus enhancing overall signal performance.

Each monitor 10 in the environment will have a 5G cellular radio 110, a 5G satellite radio 112, and a Wi-Fi radio 114 preferably with a range extender. The 5G signal can be directly received by each monitor in the environment from a 5G cellular tower 122 or 5G satellite 124, or a combination of both.

In one embodiment, the primary monitor, or “master” monitor, can receive a 5G signal 132, 134 from a 5G cellular tower 122 or 5G satellite 124, respectively, and then rebroadcast that signal throughout the environment over Wi-Fi 138. In this embodiment, the master monitor acts like a single access point.

In another embodiment, one or more monitors (maybe all of the monitors) in the environment receive a 5G signal directly from a 5G cellular tower 122 or 5G satellite 124. This eliminates the need for rebroadcasting the 5G signal over Wi-Fi.

In another embodiment, where individual monitors in the environment are not all in good (received signal strength indicator) RSSI range of the 5G signal, the various devices within the environment can establish a Wi-Fi mesh network 130 to optimize wireless communication between devices within the environment. So rather than every device only communicating with a single access point, all of the devices communicate with each other. The latency will be decreased, the RSSI will be optimized throughout the environment, and overall system performance will be greatly improved.

In yet another embodiment, electronic hardware and software within each monitor in the environment will assess signal strength amongst all potential master devices. Whichever 5G radio in the environment auto-senses the best signal, cellular or satellite, and receives the best 5G signal would be established as the master 5G node and all of the other monitors in the environment would be established as the slaves. This might change over time based upon satellite location, solar sun spot activity, and other phenomenon that affect radio wave propagation. In some cases, more than one monitor might receive the 5G cellular or 5G satellite signal 132, 134 directly and the mesh network 130 might have more than one master, and the network might be split into two or more mesh networks, or hybrid mesh networks, all within the environment.

Once a master and slaves have been established by the control hardware and software, Wi-Fi interconnectivity between devices within the environment is established through the hardware and software control system. All devices within the environment will communicate over Wi-Fi unless any such device has no Wi-Fi reception. In this case, that device would use direct 5G connectivity, or the mesh network would be automatically reconfigured to optimize signal strength and interconnectivity amongst devices.

In the event of a power failure, most access points lose power and fail to provide internet connectivity for streaming media and IoT devices. An integrated backup battery 116 will be integrated within the monitor enclosure 102, 104 to provide power to the 5G cellular radio 110, 5G satellite radio 112, and Wi-Fi radio 114 so that other independently battery powered IoT devices within the environment continue to operate, and the backup battery 116 might provide power to the monitors as well.

All patents and publications mentioned in this specification are indicative of the levels of those skilled in the art to which the invention pertains.

It is to be understood that while certain forms of the invention are illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A display monitor for displaying visual information comprising:
a screen (100) including a plurality of lights constructed and arranged to be illuminated to provide a visual display in response to receiving an electrical signal,
a front housing (102), and a rear housing (104), secured together to contain the screen (100),
at least one circuit board having at least one input/output port (108), the at least one circuit board electrically connected to the screen (100) for providing electrical signals to the screen,
a 5G radio electrically connected to the at least one circuit board, a 5G signal receivable by the at least one circuit board for display of 5G information on the screen (100).

2. The display monitor of claim 1 wherein the 5G radio is constructed and arranged to receive 5G cellular signals (132).

3. The display monitor of claim 1 wherein the 5G radio is constructed and arranged to receive 5G satellite signals (134).

4. The display monitor of claim 1 wherein the 5G transceiver includes a 5G cellular radio (110), a 5G satellite radio (112), and a Wi-Fi radio (114).

5. The display monitor of claim 4 wherein the Wi-Fi radio (114) includes a range extender.

6. The display monitor of claim 4 wherein the 5G signal is received directly from a 5G cellular tower (122) or 5G satellite (124).

7. The display monitor of claim 4 wherein a plurality of display monitors, each equipped with the 5G radio, are constructed and arranged to establish a Wi-Fi mesh network (130) to optimize wireless communication between display monitors within Wi-Fi range of each other, wherein display monitors with a weak 5G signal are provided with data by other display monitors in the mesh network (130).

8. The display monitor of claim 7 wherein the display monitor receiving the best 5G signal is established as a master display monitor of the network, the remaining display monitors being slave display monitors to the master display monitor.

9. The display monitor of claim 7 wherein, once master display devices and slave display devices have been established by a control hardware and software, Wi-Fi interconnectivity between display devices within the network is established so that all display devices within the network will communicate over Wi-Fi.

10. The display monitor of claim 9 wherein the mesh network (130) is constructed and arranged to be automatically reconfigured to optimize signal strength and interconnectivity amongst devices.

11. The display monitor of claim 10 wherein in the event of a power failure, a backup battery (116) is integrated within the monitor housing (102), (104) to provide power to the 5G cellular radio (110), 5G satellite radio (112), and Wi-Fi radio (114) so that other independently battery powered devices within the network continue to receive 5G signals.
